(19) United States
(12) Patent Application Publication
(10) Pub. No.: US 2025/0212899 A1
(43) Pub. Date: Jul. 3, 2025

(54) PLANT-ONLY LEAVENING AGENT REPLACEMENT SYSTEM IN FOOD PRODUCTS AND METHODS OF PREPARATION THEREOF

(71) Applicant: The Live Green Group, Inc.,, Middletown, DE (US)

(72) Inventors: Sasikanth Chemalamudi, San Fernando (CL); Priyanka Srinivas, San Fernando (CL)

(21) Appl. No.: 18/850,080

(22) PCT Filed: Apr. 13, 2023
(86) PCT No.: PCT/IB2023/053777

§ 371 Date: Sep. 27, 2024

Related U.S. Application Data
(60) Provisional application No. 63/333,842, filed on Apr. 22, 2022.

(51) Int. Cl. A21D 2/36; A21D 2/18; A23L 13/40

(52) U.S. Cl. CPC A21D 2/36; A21D 2/186; A23L 13/426; A23L 13/428

(57) ABSTRACT

A plant-only leavening agent replacement system in food products is provided. The plant-only leavening agent replacement system is prepared by mixing a) 15-20% by weight of a plant-derived fiber source, b) 10-25% by weight of a natural fruit acid source, c) 15-20% by weight of a plant-derived starch source, d) 15-20% by weight of a fruit pectin source, and e) 5-15% by weight of a cereal source at a temperature between 60 degrees Celsius and 105 degrees Celsius for about 30 seconds to one minute to form a homogeneous mixture. The plant-only leavening agent replacement system is used in place of commercially available synthetic leavening agents and other additives in a variety of food products.

### CROSS-REFERENCE TO RELATED APPLICATIONS

This application claims priority to the U.S. provisional patent application 63/333,842, filed on Apr. 22, 2022 and PCT provisional patent application no.: PCT/IB2023/053777, filed on Apr. 13, 2023, titled “PLANT-ONLY LEAVENING AGENT REPLACEMENT SYSTEM IN FOOD PRODUCTS AND METHODS OF PREPARATION THEREOF” and is herein incorporated by reference.

### TECHNICAL FIELD

The disclosed embodiments relate generally to food compositions and, more particularly, plant-only leavening agent replacement system, replacing the chemical, synthetic and/or highly processed leavening additives in commercially available food products such as animal- or plant-based burgers, burger mixes, other meat-based products, meat alternative products, frozen food products, baked goods and other food products, including food product mixes in which a leavening agent may be desired. Such plant-only replacements are minimally processed and are free of synthetic food additives.

### BACKGROUND

Many commercially available, processed plant-based, and animal-based food products contain natural and/or synthetic food additives as well as other highly processed ingredients. The categories of commercially available food products containing such additives vary greatly and include animal flesh-based (i.e., any one or more types of beef, pork, poultry, fish, shellfish, other seafood, etc.) or imitation meat-containing products based in whole or in part on plant-derived materials, or food products comprised of a combination both animal-source and plant-sourced materials. As an example, these food products may be, in one form, commercially available burgers and burger mixes, patties, cakes, crumbles, etc. Additives are found in all types of commercially available food products and serve as stabilizers, preservatives, colorants, flavor enhancers, sweeteners, thickeners, texturizers, and emulsifiers, and provide a variety of desired characteristics such as flavors, textures, appearance, and consistency. Additives can maximize yield, minimize shrinkage and cooking loss, and/or lead to more uniform blending or homogeneity of the food product or food product mix.

Commercially available, Traditional Burger Products are generally highly processed foods. Traditional, meat-based burgers contain meat or animal flesh of some kind, added saturated fats, bone (carcass), highly processed ingredients, synthetic additives, and other ingredients that may be inappropriate for certain diets, e.g., vegetarian, vegan, salt-restricted, low-fat, low saturated fat, culturally- or religiously-restricted diets, etc. Even some commercially available “plant-based,” “plant-derived,” “meatless,” and “meat-free” burgers and other food products (depending on how those terms are defined by the manufacturers, or under definitions supported by a governmental authority in the location of manufacture) may contain animal-derived ingredients such as bone and meat broth or gelatin, dairy products, and certain saturated fats, sourced from animals slaughtered for food, or from animals raised primarily for dairy product production. Such animal-derived additions can render even these “plant-based” burgers and burger mixes inappropriate for vegetarians and vegans.

Some meat substitutes have been developed, in part, to mimic the qualities that some consumers of plant-based alternatives desire in a burger: a juicy center, red color and meaty (or umami) taste but often a significant amount of saturated fat must be added to achieve a desired consistency or texture. Food additives in Traditional Burger Products may have physiological effects that many consumers do not want or do not want to risk if a healthier, more sustainable alternative is available that does not pose the downsides. Examples of food additives commonly found in Traditional Burger Products include silicon dioxide, sodium benzoate, sodium nitrite, and artificial food colors. Many such additives (particularly synthetic additives) can be harmful to consumers if consumed over prolonged periods. The food industry uses more than 7,000 synthetic and ultra-processed additives even though nature offers more than ten million compounds from more than 450,000 plants. Leavening additives used in the food industry other than leavening agents include, among others, baking powders, baking soda, and yeasts, all of which release gas (carbon dioxide) when interacting with any of other leavens, other ingredients in the mix, with heat or with water.

Leavening additives, also known as leavening agents, leavening agents, rising agents, etc., (“leavening agents”) are substances used in food products that cause a foaming action (producing carbon dioxide or hydrogen gas) that make the product expand, lightening it and softening it due to the incorporation of air in the product.

Leavening agents can be biologic or synthetic, chemical compounds. Baking powder and baking soda include acids and bicarbonate salts, which, when combined with water, for example, produce gas in a wet or moist mixture to expand and thus leaven the mixture, altering the volume and texture of the final product. Starch is often added to the system to improve product stability and consistency. Synthetically produced baking powder only acts as a leavening agent but does not also contribute nutrients to the food product.

It would be desirable to provide solely plant- or fungi-derived (hereafter, “plant-only,” as further defined below) ingredients that replace typical, synthetic, artificial, and/or animal-derived (i.e., sourced directly or indirectly from an animal) leavening agent ingredients found in meats and meat substitutes such as Traditional Burger Products, as well as in bread and other baked goods. A “plant-only” food product is free from dairy and other animal-derived ingredients and is minimally processed, with/or, as a component of another food product, contributing to a desirable flavor, taste, texture, homogeneity, consistency, color and appearance so as to be aesthetically pleasing prior to consumers.

### SUMMARY

Aspects of the disclosure are provided herein for a plant-only leavening agent replacement system and components thereof to be used in place of commercially available, (frequently) synthetic leavening agents and other additives in a variety of food products. Commercially available, meat-based and/or imitation meat-based food products such as highly processed plant-based, plant-derived, meatless or meat-free burgers, burger mixes and other types of imitation meats and meat-alterative products (together, “Traditional Burger Products”) are one category of food products that can benefit from the substitution of leavening agents and other traditional additives for plant-only ingredients and additives that are minimally processed. In the disclosed embodiments of the leavening agent replacement system, plant-only ingredients effectively function as texturizing agents and volume enhancers in food products, replacing the conventional, non-plant-derived, synthetic, or highly processed additives and ingredients normally found in Traditional Burger Products and other commercially available food products. In the disclosed embodiments, plant-only food additive replacements (or replacement systems) are comprised of only minimally processed, naturally occurring (i.e., non-synthetic) ingredients sourced solely within the plant or fungi kingdoms.

According to an aspect of the disclosed embodiments, a plant-only leavening agent replacement system in food products is provided. The plant-only leavening agent replacement system includes a) 15-20% by weight of a plant-derived fiber source, b) 10-25% by weight of a natural fruit acid source, c) 15-20% by weight of a plant-derived starch source, d) 15-20% by weight of a fruit pectin source, and e) 5-15% by weight of a cereal source.

According to an embodiment, the plant-derived fiber source is selected from psyllium husks, chia, bamboo, Quinoa fibers, pea fiber, oat fiber, soy fiber, corn fiber, Phaseolus vulgaris flour, chickpea flour or combinations thereof.

According to another embodiment, the natural fruit acid source is selected from prunes, peaches, apricots, apples, olives, loquat, sweet cherries, mangoes, Indian gooseberries, nectarines or combinations thereof.

According to yet another embodiment, the plant-derived starch source is selected from Faba beans, potato flour, tapioca starch, rice starch, Jackfruit seed powder, Taro starch, Yam starch, Arrowroot starch, Cassava starch, wheat starch or combinations thereof.

According to yet another embodiment, the fruit pectin source is selected from Apples, bananas, acerola, Jujube pomace, Redcurrant, blackberry, strawberry, orange pomace, dragon fruit peel, raspberry or combinations thereof.

According to yet another embodiment, the cereal source is selected from rice, sorghum, millet, Barley, wheat, maize, oats, rye, amaranth, ragi or combinations thereof.

According to yet another embodiment, the food products comprise meat-based and meat substitute products formed as nuggets, sausages, patties, frozen burger or burger mix, quick breads, cakes, cookies, refrigerated biscuit dough, crackers, biscuits, pastries, pies and prepared cereals.

According to another aspect of the disclosed embodiments, a method of preparing a plant-only leavening agent replacement system in food products is provided. The method includes mixing a) 15-20% by weight of a plant-derived fiber source, b) 10-25% by weight of a natural fruit acid source, c) 15-20% by weight of a plant-derived starch source, d) 15-20% by weight of a fruit pectin source, and e) 5-15% by weight of a cereal source at a temperature between 60 degrees Celsius and 105 degrees Celsius for about 30 seconds to one minute to form a homogeneous mixture of the plant-only leavening agent replacement system.

According to an embodiment, the method includes blending the plant-only leavening agent replacement system with a formulation of the food product in a blender or bowl cutter.

According to another embodiment, the plant-derived fiber source, the natural fruit acid source, the plant-derived starch source, the fruit pectin source and the cereal source are obtained as a dried powder.

According to yet another embodiment, the plant-only leavening agent replacement system is obtained as a gel or dough.

According to yet another embodiment, the plant-derived fiber source is selected from psyllium husks, chia, bamboo, Quinoa fibers, pea fiber, oat fiber, soy fiber, corn fiber, Phaseolus vulgaris flour chickpea flour or combinations thereof.

According to yet another embodiment, the natural fruit acid source is selected from prunes, peaches, apricots, apples, olives, loquat, sweet cherries, mangoes, Indian gooseberries, nectarines or combinations thereof.

According to yet another embodiment, the plant-derived starch source is selected from Faba beans, potato flour, tapioca starch, rice starch, Jackfruit seed starch powder, Taro starch, Yam starch, Arrowroot starch, Cassava starch, wheat starch or combinations thereof.

According to yet another embodiment, the fruit pectin source is selected from Apples, bananas, acerola, Jujube pomace, Redcurrant, blackberry, strawberry, orange pomace, dragon fruit peel, raspberry or combinations thereof.

According to yet another embodiment, the cereal source is selected from rice, sorghum, millet, Barley, wheat, maize, oats, rye, amaranth, ragi or combinations thereof.

According to yet another embodiment, the food products comprise meat-based and meat substitute products formed as nuggets, sausages, patties, frozen burger or burger mix, quick breads, cakes, cookies, refrigerated biscuit dough, crackers, biscuits, pastries, pies, and prepared cereals.

According to yet another embodiment, physical characterization data associated with ingredients of the plant-only leavening agent replacement system comprising the plant-derived fiber source, the natural fruit acid source, the plant-derived starch source, the fruit pectin source and the cereal source is stored in a database, wherein a machine learning model determines a unique combination of ingredients based on the physical characterization data to prepare the plant-only leavening agent replacement system.

According to yet another embodiment, the physical characterization data of the ingredients comprise functional properties that comprise emulsification properties, stabilization properties, gelling properties, fat-replacement properties, Ayurvedic and/or other holistic properties, physicochemical properties that comprise pH, viscosity, moisture content, density, mechanical properties that comprise adhesive strength, tensile strength, shear resistance, chemical and/or molecular descriptor properties that comprise bio-active/bioavailability properties, molecular structure, phytonutrient properties, sensorial properties that comprise taste, smell, color, texture, mouth feel, and nutritional information that comprises macronutrient/micronutrient properties.

Several aspects of the disclosed embodiments are described below with reference to examples for illustration. However, one skilled in the relevant art will recognize that the disclosed embodiments can be practiced without one or more of the specific details or with other methods, components, materials, and so forth. In other instances, well-known structures, materials, or operations are not shown in detail to avoid obscuring the features of the disclosed embodiments. Furthermore, the features/aspects described can be practiced in various combinations, though only some of the combinations are described herein for conciseness.

### BRIEF DESCRIPTION OF THE DRAWINGS

Example embodiments of the disclosed embodiments will be described with reference to the accompanying drawings briefly described below.

FIG. 1 illustrates a flow chart of a method of preparing a plant-only leavening agent replacement system in food products according to the aspect of the present disclosed embodiments.

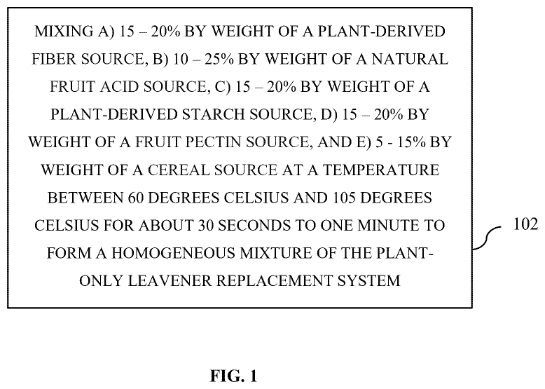

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE DISCLOSED EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another. Further, the terms “comprising,” “including,” “having,” and the like, as used with respect to embodiments of the present disclosure, are synonymous. As used herein, the terms “agent,” “component,” or “ingredient” are used interchangeably and refer to a particular item that includes one or more chemical compounds (e.g., a food item from one or more plants that comprise one or more naturally occurring chemical compounds).

The term “component” or “ingredient” as used herein, refers to a particular item that includes one or more chemical compounds, i.e., edible compounds sourced from plants, fungi or algae that comprise one or more naturally occurring chemical compounds.

Alternative embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

As used herein, the singular forms “a”, “an”, and “the” include both singular and plural referents unless the context clearly dictates otherwise. By way of example, “a dosage” refers to one or more than one dosage.

The terms “comprising”, “comprises” and “comprised of” as used herein are synonymous with “including”, “includes” or “containing”, “contains”, and are inclusive or open-ended and do not exclude additional, non-recited members, elements or method steps.

All documents cited in the present specification are hereby incorporated by reference in their totality. In particular, the teachings of all documents herein specifically referred to are incorporated by reference.

Example embodiments of the disclosed embodiments are described with reference to the accompanying figures.

In the drawings, like reference numbers generally indicate identical, functionally similar, and/or structurally similar elements. The drawing in which an element first appears is indicated by the leftmost digit(s) in the corresponding reference number.

### Definitions

“Leavening agent” refers to a substance causing the expansion of doughs and batters by the release of gases within such mixtures, producing baked products with porous structures.

“Proteins” refers to large biomolecules and macromolecules that comprise one or more long chains of amino acid residues.

“Fiber” refers to the portion of plant-derived food that cannot be completely broken down by human digestive enzymes.

“Starch” refers to a polymeric carbohydrate consisting of numerous glucose units.

“Fruit acid” refers to alpha-hydroxy acids (AHAs), a group of nontoxic organic compounds.

“Fruit pectin” refers to a soluble fiber (polysaccharide) found in fruits.

“Bulking” refers to increasing the volume or weight of a product without affecting the overall taste and aroma of the product

“Texturizing” refers to improving the overall consistency, texture by enhancing features like creaminess, viscosity, mouthfeel and taste

“Fat” refers to a type of lipid consisting of triesters of glycerol and fatty acids or triglycerides.

“Fruit puree” refers to making fruit or vegetables into a thick, smooth sauce by crushing.

“Derived sugars” refers to modified monosaccharides.

“Cream” refers to a thick yellowish-white liquid.

“Emulsifier” refers to an agent used to help mix two substances that typically separate when they are combined.

“Thickener” refers to a substance that increases the viscosity of a liquid without substantially changing its other properties.

“Stabilizer” refers to an additive to food that helps to preserve its structure.

“Flavoring agent” refers to an additive that provides an additional taste or flavor.

“Homogeneous mixture” refers to a mixture that has the same proportions of its components throughout a given sample.

“Blender” refers to an appliance used to mix, crush, purée or emulsify food and other substances.

“Machine learning model” refers to computer software designed to recognize patterns or behaviors based on previous experience or data.

“Plant-derived” refers to ingredients extracted from a plant.

“Plant-only” products disclosed herein, as opposed to products labeled as “plant-based,” and the like, refer to food products whose ingredients, apart from any significant amount of water added, are derived solely from sources outside of the animal kingdom, e.g., from plants, fungi, or algae. That is, “plant-only” may refer to any composition, formulation, system or the entire food product, that is produced, developed, or otherwise obtained directly or indirectly from one or more plants, fungi, or algae, is not synthetic, and is only minimally processed for production, e.g., cleaned, dried, pulverized, etc.

The term “food product” refers broadly to any edible food or product, raw or cooked, savory or sweet, whether intended for human or animal consumption; a food product may be edible although not intended to be consumed on its own but, rather, incorporated into a second (or third) food product that is considered a consumable.

The Applicant, Live Green Company, is the market maker of the Plant-only category, which means that all the animal, synthetic and ultra-processed ingredients are replaced by plant-derived ingredients with superior nutritional profiles without impacting the original organoleptic properties.

A plant-only food product or formulation that is free from dairy and other animal-based ingredients is described herein that has desirable flavor, taste, texture, homogeneity, consistency, color and appearance so as to be aesthetically pleasing prior to consumption. The terms “plant-derived is used,” in this disclosure to refer to any ingredient, or component of a food product that is derived or extracted or obtained from plants with minimal processing. The term plant-only is used in this disclosure to refer to a system, composition, formulation or the entire food product itself, that is produced, developed or otherwise obtained directly or indirectly from one or more of the plant-derived ingredients, component that is obtained from plants with minimal processing. Although a plant-only, food product may consist of materials that are 100 percent sourced from one or more plants, the term also encompasses food products that may contain components or ingredients that are not obtained from plants. For example, while some of the water content of a food product may be derived from a plant source, water may also be added to the product from an external source. For example, in scenarios in which a plant-only system or plant-only food product is in the form of a gel or liquid, it is further understood that water can be included as a solvent or liquid carrier for the plant-only system or plant-only food product, where any amount of water (some or all) within the system or food product may or may not be derived from a plant source. In some embodiments, apart from added water, the plant-only food product consists entirely (100%) of components or ingredients from a plant genus (i.e., photosynthetic eukaryotes from the kingdom Plantae), and further excluding any component or ingredient that is dairy-based, that is from the animal genus (including animal fats and animal proteins) and also excludes any synthetically derived component or ingredient. The plant-derived ingredients of the food product described herein replace conventional animal-based ingredients, including milk, cream and eggs, as well as conventional additives such as gums, stabilizers, emulsifiers, preservatives, anti-freezing and anti-caking agents, binders, etc. The product formed solely from plant-derived ingredients is further free from gluten, soy, cholesterol and trans fatty acids.

The selection of specific plant-derived ingredients, or specific combinations (i.e., systems) of plant-derived ingredients provides effective functionalities such as emulsifiers, stabilizers, texturizing and thickening, fat replacement, sugars or other sweeteners, anti-freezing properties, anti-caking properties, etc., for the food product without the need to add such conventional, non-plant-derived additives. As used herein, the terms “agent,” “component,” or “ingredient” are used interchangeably and refer to a particular item that includes one or more chemical compounds (e.g., a food item from the plant species that comprises one or more naturally occurring chemical compounds). The term “plant-derived”, as used herein, refers to a product or formulation (e.g., food product or food formulation).

Embodiments disclosed herein include the plant-only leavening agent replacement system, or components of it, for replacing various ingredients or combinations of ingredients traditionally found in commercially available food products, including Traditional Burger Products. In some embodiments, the leavening agent replacement system or aspects of the system replace part of the meat or fibrous material as well as the additives of a (meat-based or plant-derived) Traditional Burger Product. In other embodiments, the leavening agent replacement system or components of it complement the ingredients of plant-based or plant-derived Traditional Burger Products, by providing more plant-only protein and non-synthetic additive sources that enhance the nutritional value of the food product. In still other embodiments the leavening agent replacement system replaces all animal-derived ingredients of, so-called “plant-derived,” “plant-based” or meatless, imitation meat food products, including food product mixes.

“Plant-only” products disclosed herein, as opposed to products labeled as “plant-derived,” “plant-based,” “meatless,” “meat-free” and the like, refer to food products whose ingredients, apart from any significant amount of water added, are derived solely from members of the plant or fungi kingdoms. That is, “plant-only” may refer to any agent, ingredient, or component of a food product, or the entire food product itself, that is produced, developed, or otherwise obtained directly or indirectly from one or more plants or fungi, is not synthetic, and is only minimally processed for production, e.g., cleaned, dried, pulverized, etc.

While some manufacturers may refrain from including any ingredients sourced from animals in their “plant-based” (and other similarly labeled) products, the term “plant-based” may also encompass ingredients and food products that may be obtained from outside the plant or fungi kingdoms. The US Food and Drug Administration currently has no accepted standard definition for labeling of food products described as “plant-based” or “plant-derived,” although a private trade organization, the Plant Based Food Association, has proposed voluntary standards to ensure consistency when the term “plant-based” is used on a product label (i.e., it contains no animal-sourced content), and seeks to certify—through its own certification process-food products, including food product mixes, that meet this standard (https://www.plantbasedfoods.org/policy/labeling/). The terminology used on a label for a plant-based food must be truthful under FDA regulations. However, in the US, no regulatory body currently requires a company to refrain from including some amount of meat, animal flesh or other animal-sourced ingredients in a “plant-based” product.

In certain embodiments, while some of the water content of a food product may be derived from a plant source, water may also be added to the product from an external source. For example, in scenarios in which a plant only agent or system or plant only food product is in the form of a gel or liquid, it is further understood that water can be included as solvent or liquid carrier for the plant-only system, ingredient or food product, where any amount of water (some or all) within the system, ingredient or food product may or may not be derived from a plant source. In some embodiments, water may be added from an external source as part of the plant-only leavening agent replacement system (or any other plant-only replacement system referenced herein). In other embodiments the plant only leavening agent replacement system may be available in a dried form; in certain embodiments the dried form may be powdered; in other embodiments, the dried form of the leavening agent replacement system may be in a partially powdered form; in other embodiments it may be available in a semi-liquid or gel form; in other embodiments it may be in a liquid or frozen form.

In the disclosed embodiments, apart from externally-sourced water, the plant-derived food product consists entirely of ingredients derived from members of the plant or fungi kingdoms, excluding any component or ingredient that is: (i) dairy-based or otherwise derived from any member of the animal kingdom; and (ii) more than minimally processed; and (ii) synthetic. In some embodiments, the plant-only leavening agent replacement system, or components thereof, replace conventional ingredients and additives found in meat-based food products such as commercially available meat-based burgers. In other embodiments the leavening agent replacement system replaces those additives found in commercially available plant-based, plant-derived, meatless, meat-free food products that range from burgers and burger mixes to baked goods and frozen food products.

Alternative embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, regardless of whether it is expressly described herein, one of ordinary skill in the art would readily appreciate that each of the particular features, structures, or characteristics of the given embodiments may be utilized in connection or combination with those of any other embodiment discussed herein.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

Further, the terms “comprising,” “including,” “having,” and the like, as used with respect to embodiments of the present disclosure, are synonymous. As used herein, the terms “agent,” “component,” or “ingredient” are used interchangeably and refer to a particular item that includes one or more chemical compounds (e.g., a food item from one or more plants that comprise one or more naturally occurring chemical compounds).

The term “component” or “ingredient” as used herein, refers to a particular item that includes one or more chemical compounds, e.g., a food item from a member of the plant or fungi kingdoms that comprises one or more naturally occurring chemical compounds.

### Functionality and Parameters

TABLE 1
Parameter ranges associated with ingredients of the plant-
only leavening agent replacement system in food products

| Categories | Parameters | | | |
|---|---|---|---|---|
| 1. Plant- | Water holding | Mechanical | Hemicellulose fiber | |
| derived | capacity | properties | content: >12% | |
| fiber | 3.5-33 g/g or more | like Young's | In some cases, overall | |
| source(s) | Note: WHC | modulus: >3.015 KPa | total dietary fiber is | |
| | increases with | | taken under | |
| | temperature | | consideration | |
| 2. Natural | Presence of organic | Gas retention | | |
| Fruit acid | acids like malic acid | coefficient (R) of | | |
| sources | | percentage of | | |
| | | malic acid: | | |
| | | i.e. around 0.3% | | |
| | | MA has 67.40% | | |
| | | gas retention | | |
| | | ability. | | |
| 3. Plant- | Pasting | Peak/Maximum | WAC/WHC: | Amylose |
| derived | Temperature: | viscosity (BU) | 415.13-595.26% | content: |
| starch | 68.6-69.3° C. | 0.1 and 0.9 Pa · s, at | Swelling power: | 15-30% |
| source(s): | | a shear rate of | 20.76-26.92% | |
| | | 115 s−1 | | |
| 4. Fruit | Emulsion stability | Oil Holding | Water holding capacity | |
| pectin | 35% to 80% or more | Capacity: | 3-17 g/g or more | |
| source(s) | | 2.97-11 g of oil/g | | |
| | | of sample | | |
| 5. Cereal | Type of organic | pH required by | pH reducing ability: | |
| source(s): | acids like gluconic | organic acid for | The ability to reduce pH | |
| | acid, oxalic acid, | chelation: >5.5 | varies among the organic | |
| | fumaric acid, citric | (taken for | group of acidulants in | |
| | acid, and sorbic acid, | gluconic acid | the decreasing order of | |
| | tartaric, shikimic | here) | fumaric > tartaric > | |
| | acids etc. | | malic > acetic > citric > | |
| | | | lactic > gluconic acids. | |

The selection of a specific combination of ingredients for plant-only products was determined using a proprietary machine learning (ML) platform, which blends ancestral wisdom of plant nutrition with biotechnology and ML to analyze members of the plant and fungi kingdoms and from plants and fungi, the compounds nature offers. The platform utilizes algorithms and includes a database with a significant number of ingredients (e.g., 50,000-100,000 ingredients) and relevant physical properties associated with such ingredients. For example, physical characterization data and information about each ingredient for some or all of the ingredients in the database include, without limitation, functional properties (e.g., emulsification properties, stabilization properties, bulking properties, texturizing properties, gelling properties, fat-replacement properties, etc.). Ayurvedic and/or other holistic properties, physicochemical properties (e.g. pH, viscosity, moisture content, density, etc.), mechanical properties (e.g. adhesive strength, tensile strength, shear resistance, etc.), chemical and/or molecular descriptor properties (e.g., bio-active/bioavailability properties, molecular structure, phytonutrient properties, etc.), sensorial properties (e.g., taste, smell, color, texture, mouth feel, etc.), and nutritional information (e.g., macronutrient/micronutrient properties, etc.) are also considered in the proprietary system to give optimal results in terms of functionality, health and sustainability. Based upon the known properties of ingredients in the database, the desired properties for the food product or formulation, and one or more algorithms associated with the proprietary machine learning platform, a unique combination of plant-only ingredients was determined to yield an effective leavening agent replacement formulation that can be used to forming a desirable food product or formulation that is effective as a substitute for conventional ingredients in Traditional Burger Products or for providing leavening agent-like functionality in plant-only burger products and other food products.

As noted, the proprietary system identifies natural alternatives, i.e., plant-only alternatives to synthetic, artificial, and animal-derived products, and incorporates, among other things, traditional knowledge known as Ayurvedic medicine. Ayurvedic medicine and its diet principles have been practiced for many thousands of years. This ancient system, among other things, categorizes food by its medicinal properties and desired effects; thus, the proper application of Ayurvedic principles requires knowledge of the self—one's dominant energy, also known as dosha—to prescribe the most advantageous categories of foods from which to choose for an individual's diet. Categories of Ayurvedic properties include but are not limited to Virya (hima/sheeta—cold), Vipaka (Madhura—sweet), Rasa (Madhura—sweet), and Guna (ruksa—dry; or guru—heavy). The information recommended by the proprietary machine learning platform permits one to choose between hundreds of alternatives based on ingredients intended to alter a variety of properties to give optimal results for physiological functionality, health, and environmental sustainability.

The physical characterization data associated with the ingredients of the plant-only leavening agent system in food products are stored in a database. A machine learning model determines a unique combination of ingredients based on the physical characterization data to prepare the plant-only leavening agent replacement system. The machine learning model identifies plant-based ingredient replacements based on the parameters and ranges to give the list of ingredients for each possible functionality.

### EXAMPLE EMBODIMENTS

The disclosed embodiments are illustrated in further detail by the following non-limiting examples.

TABLE 2
Percent by weight of each of the preferred, essential, leavening
agent replacement categories of ingredients in the plant-only
leavening agent replacement system in food products.

| Preferred, Essential Plant-Only | Preferred Weight |
|---|---|
| Leavening agent Replacement System | Percent of the |
| Categories/Ingredients | Replacement System |
| 1. Plant-derived fiber source(s): any one or more of psyllium | 15-20 |
| husks, chia, bamboo, and/or any substitute(s) exhibiting the | |
| same properties and functionalities | |
| 2. Natural Fruit acid source(s): any one or more of plums, | 10-25 |
| peaches, apricots, and/or any substitute(s) exhibiting the same | |
| properties and functionalities | |
| 3. Plant-derived starch source(s): any one or more of faba | 15-20 |
| beans, potato flour, tapioca starch, rice starch, and/or any | |
| substitute(s) exhibiting the same properties and functionalities | |
| 4. Fruit pectin source(s): any one or more of apples, bananas, | 15-20 |
| acerola, and/or any substitute(s) exhibiting the same properties | |
| and functionalities | |
| 5. Cereal source(s): any one or more of rice, sorghum, millet, | 5-15 |
| and/or any substitute(s) exhibiting the same properties and | |
| functionalities | |

In Table 2 within each of the five categories, the individual ingredients and combinations of two or more of them may be substituted for any of the others in that category. In some embodiments, for each category, a complete blend consisting of all of the named ingredients may be prepared for use in the leavening agent replacement system.

In alternative embodiments for each of the categories of Table 2, it is expected that any of the individual ingredients listed may be replaced with one or more substitute ingredients that impart the same or similar properties and functionalities as each of the ingredients listed.

Further, although Table 2 provides a preferred, essential list of categories of ingredients with certain properties in the leavening agent replacement system, substitutions for these ingredients in the replacement system may be made in alternative embodiments for compliance with dietary requirements; without limitation, such as food sensitivities and food allergies. For example, in the protein category, if peanuts are selected as a desired protein source for a particular food product, peanut allergies in consumers would require finding a suitable alternative to develop a formulation free from peanuts so that an anaphylactic (allergic) reaction would not be triggered in the consumer with such allergies.

The plant-only leavening agent replacement system detailed in Table 2 as a component of a plant-only burger product or a Traditional Burger Product comprises generally between about 0.5 to about 1 percent of the total weight of the food product (e.g., Table 3 below), but may vary between as much as 0.01 percent to about 10 percent of the total weight, depending on the moisture content of the leavening agent replacement system and that of the final food product (e.g., whether a plant-only burger product or a Traditional burger Product, whether a dry mix or other form).

TABLE 3
Various replacement systems' ingredients and combinations
as components of plant-only burger products

| | Preferred Weight |
|---|---|
| | Percent of |
| Preferred, Essential, Plant-Only Food Product Replacement | Plant-Only Burger |
| Systems and/or Individual Ingredients and Combinations | Product (dry weight) |
| Protein sources (one or more of pea, mushroom, quinoa, | 10-20 |
| chickpeas) | |
| Methyl Cellulose (MC) replacement system ingredients from | 5-10 |
| all five categories (proteins; fibers from whole grains, fruits, | |
| seeds and vegetables; starches; and vegetable binders) | |
| within the ranges indicated for the replacement system | |
| Modified Starches replacement system comprising four | 10-15 |
| starch source categories, including, among other ingredients, | |
| tapioca starch, faba bean starch, sorghum starch, quinoa starch | |
| and/or substitute(s) exhibiting similar or the same properties | |
| and functionalities) | |
| Oils providing high levels of omega-3 fatty acids, MUFAs, & | 10-12 |
| MCTs (e.g., sunflower oil, coconut oil, flaxseed oil, rice bran | |
| oil, or other oil providing such fats at desired levels) | |
| Gums and Carrageenan replacement system (one or more of | 10-15 |
| quince seed, apple, mesquite, almonds) | |
| Shelf life extenders (one or more of garlic, black | 1-2 |
| pepper, oregano, bay laurel) | |
| Umami flavor (one or more of shitake and other mushrooms, | 0.5-2 |
| tomatoes, garlic, lotus stalk, onions, salt) | |
| Flavorant, flavor enhancer, nutraceutical (one or more of cumin, | 0.5-1 |
| coriander, paprika, black pepper) | |
| Flavor Enhancer (one or more of nutritional yeast, cashews) | 1-2 |
| Mineral Salts (Himalayan pink salt, sea salt, etc.) | 0.5-2 |
| Binding agents (one or more of chickpeas, oat fiber, aquafaba, | 5-10 |
| sugar beet pectin) | |
| Leavening agent replacement system ingredients from all | 0.5-1 |
| five categories detailed in Table 2 (plant-derived fibers; fruit | |
| pectins; fruit acids; plant-derived starches; and cereal sources) | |
| within the ranges indicated for the replacement system (e.g., | |
| one or more of plum powder, apple cider vinegar, vegan | |
| buttermilk, and others) | |
| Leghemoglobin source(s) (one or more of beets, soy, red radish) | 1-2 |
| Lipid peroxidation inhibitors (one or more of black pepper, bay | 0.5-2 |
| leaf, cumin) | |

The leavening agent replacement system may comprise, as a percent by weight of the food product in which it is added, depending on the type of food product and whether water or other liquid is included as part of the food product, included but not limited to Traditional Burger Products and plant-only burger products, between about 0.05 to about 20 percent, between about 0.01 to about 0.10 percent, between about 0.10 to about 0.15 percent, between about 0.15 to about 0.20 percent, between about 0.20 to about 0.25 percent between about 0.25 to about 0.30 percent, between about 0.30 to about 0.35 percent, between about 0.35 to about 0.40 percent, between about 0.40 to about 0.45 percent, between about 0.45 to about 0.50 percent, between about 0.50 to about 0.65 percent, between about 0.65 to about 0.70 percent, between about 0.70 to about 0.75 percent, between about 0.75 to about 0.80 percent, between about 0.80 to about 0.85 percent, between about 0.85 to about 0.90 percent, between about 0.90 to about 0.95 percent, between about 0.95 to about 1.00 percent, between about 1.00 to about 1.05 percent, between about 1.05 to about 1.10 percent, between about 1.10 to about 1.15 percent, between about 1.15 to about 1.25 percent, between about 1.25 to about 1.35 percent, between about 1.35 to about 1.50 percent, between about 1.50 to about 1.75 percent, between about 1.75 to about 2.00 percent, between about 2.00 to about 2.25 percent, between about 2.25 to about 2.50 percent, between about 2.50 to about 2.75 percent, between about 2.75 to about 3.00 percent, between about 3.00 to about 3.25 percent, between about 3.25 to about 3.5 percent, between about 3.5 to about 4.5 percent, between about 4.5 to about 5.5 percent, between about 5.5 to about 6.5 percent, between about 6.5 to about 7.5 percent, between about 7.5 to about 8.5 percent, between about 8.5 to about 9.5 percent, between about 9.5 to about 10 percent, between about 10 to about 13 percent, between about 13 to about 16 percent, and between about 16 to about 20 percent.

### Categories of Ingredients Among the Preferred, Essential Categories of Ingredients in the Leavening Agent Replacement System

A principal ingredient category in a leavening agent replacement system for burger products in particular is one or more plant-derived fiber sources such as psyllium husks or chia.
Category 1: plant-derived fiber source(s): Psyllium husk is one example of a fiber source that can be used as part of the leavening agent replacement system in food products. Alternative sources include chia and bamboo, each of which, in this leavening agent replacement system designed by the machine learning system, may be interchanged with the others or may be used in combination of two or more of these ingredients, or with (or substituted by) other ingredients known to a person of ordinary skill that would provide the same or similar characteristics and features (functionality and properties) for this category in the system. Further detail on this category is found in Table 7.

Psyllium husk—Psyllium husk is an excellent source of soluble dietary fiber. It is used in food products as a thickener due to its high hemicellulose content. It is gluten-free, low in carbohydrates, and tasteless. In meat substitutes (analogues) it retains water, resulting in increased cooking yield and decreased shrinkage of the product. In some embodiments, psyllium husk is provided in the leavening agent replacement system as a finely ground powder. In other embodiments, it may be mixed with water, plant-derived liquid or other liquid to form a liquid, gel or other alternatives forming the system suitable for mixing and storing, freezing and/or drying. Psyllium husk promotes the ayurvedic properties of Rasa (Taste): Madhura (Sweet), Guna: Guru (Heavy), Viraya: Hima (Cool), Vipaka: Madhura.

In the disclosed embodiments the amount of plant-derived fiber sources (one or more of psyllium husk, chia, bamboo and/or one or more substitutes that have the same or similar properties and functionalities as these ingredients) as a percentage of the leavening agent replacement system weight ranges between about 5 to about 35 percent, between about 5 to about 10 percent, between about 7 to about 12 percent, between about 8 to about 15 percent, between about 10 to about 17 percent, between about 12 to about 18 percent, between about 15 and about 20 percent, between about 17 to about 25 percent, between about 20 to about 28 percent, between about 25 to about 32 percent, and between about 28 to about 35 percent.
Category 2: Natural Fruit acid source(s): Dried plums (prunes) is one example of a fruit whose acid content serves as a natural leavening component in food products. Alternative sources include apricots, peaches, and other drupe fruits. Each of these may be interchanged with one or more of the others or two or more may be used in combination or may be substituted by other ingredients known to a person of ordinary skill that would provide the same characteristics and features (properties, functionalities) as other ingredients in this category of the system. Further detail on this category is found in Table 7.

Dried plums (prunes) contain about 2% naturally occurring malic acid, which has served to be the natural acid component of chemical leavening systems. Acidic ingredients play an important role in both raising and tenderizing action in a food product. Malic acid also contributes as a preservative. In some embodiments, prunes are provided in the leavening agent replacement system as a finely ground powder. In other embodiments, it may be mixed with water, plant-derived liquid or other liquid to form a liquid, gel or other alternatives forming the system suitable for mixing and storing, freezing and/or drying. Plums promote the ayurvedic properties of Rasa: Madhura (Sweet), Kashya (Astringent), Guna: Guru (Heavy), Virya: Ushna (heat), Vipaka: Madhura (Sweet).

In the disclosed embodiments the amount of natural fruit acid source(s) (one or more of apricots, peaches, and other drupe fruits) as a percent of the leavening agent replacement system weight, ranges from about 1 to about 30 percent, between about 1 to about 5 percent, between about 3 to about 10 percent, between about 5 to about 10 percent, between about 5 to about 15 percent, between about 10 to about 15 percent, between about 10 to about 20 percent, between about 15 and about 20 percent, between about 15 to about 25 percent, between about 20 to about 25 percent, and between about 25 to about 30 percent.
Category 3: plant-derived starch source(s): Faba beans are one example of a source of plant-derived starches that can be used as part of the leavening agent replacement system in food products. Alternative sources include tapioca starch, rice starch, and potato starch, each of which may be interchanged with the others or may be used in combination with two or more of these ingredients, or with (or substituted by) other ingredients known to a person of ordinary skill that would provide the same characteristics and features (properties, functionalities) for this category in the system. Further detail on this category is found in Table 7.

Faba beans are an important source of vitamins and minerals and act as a buffer of sorts, avoiding premature reaction of the basis and acids present in the ingredients of the leavening agent replacement system. Faba beans and their starch can be used as a meat substitute in mean substitute products, resulting in lower cooking losses and shrinkage. They improve texture, keeping the flavor and, when the food product is stored as a frozen food, they resist changes in peroxide values in the product. In some embodiments, faba bean starch is provided in the system as a finely ground powder. In other embodiments it may be mixed with water, plant-derived liquid or other liquid to form a liquid, gel or other alternatives forming the system suitable for mixing and storing, freezing and/or drying. Faba bean starch promotes the ayurvedic properties of Rasa: Kashya (Astringent) Guna: Guru (Heavy), Ruksha (Dry), Vipaka: Kashaya (Astringent).

In the disclosed embodiments, the amount of fiber from plant-derived starches (one or more of faba beans, rice starch, tapioca starch, potato starch, or a substitute with the same or similar properties and functionalities as these) as a percent of the leavening agent replacement system weight, ranges from between about 5 to about 35 percent, between about 5 to about 10 percent, weight between about 7 to about 12 percent, between about 8 to about 15 percent, between about 10 to about 17 percent, between about 12 to about 18 percent, between about 15 and about 20 percent, between about 17 to about 25 percent, between about 20 to about 28 percent, between about 25 to about 32 percent, and between about 28 to about 35 percent.
Category 4: Fruit pectin source(s): Apple pomace is are one example of a source of a fruit whose pectin content serves as a natural leavening agent component in food products that can be used as part of the leavening agent replacement system in food products. Alternative sources include banana and pear, each of which may be interchanged with the others or may be used in combination with two or more of these ingredients, or with (or substituted by) other ingredients known to a person of ordinary skill that would provide the same characteristics and features for this category in the system. Further detail on this category is found in Table 7.

Apple—the pectin in apple pomace results in high emulsion stability and contributes to maintain air trapped in the food product. Apple has a high content of glucono-delta-lactones, a natural leavening agent. Apple pectin has a high water holding capacity and as a result, improves cooking yield, thickness and firmness in meat and meat substitute products formed as nuggets, sausages and patties. Soluble fibers provide structural integrity and stability in the product. In some embodiments, apple pomace is provided in the system as a finely ground powder. In other embodiments it may be mixed with water, plant-derived liquid or other liquid to form a liquid, gel or other alternatives forming the system suitable for mixing and storing, freezing and/or drying. Apple pomace promotes the ayurvedic properties of Rasa: Madhura (Sweet), Astringent (Kashaya), Guna: Guru (Heavy), Viraya: Sheeta (Cold), Vipaka: Madhura (Sweet).

In the disclosed embodiments, fruit pectin source(s) (one or more of apple, banana, pear and/or a substitute with the same or similar properties and functionalities as these ingredients) as a percent of the leavening agent replacement system weight, ranges from between about 5 to about 35 percent, between about 5 to about 10 percent, weight between about 7 to about 12 percent, between about 8 to about 15 percent, between about 10 to about 17 percent, between about 12 to about 18 percent, between about 15 and about 20 percent, between about 17 to about 25 percent, between about 20 to about 28 percent, between about 25 to about 32 percent, and between about 28 to about 35 percent.
Category 5: cereal source(s) Rice is one example of a source of cereal that can be used as part of the leavening agent replacement system in food products. Alternative sources include sorghum and millet, each of which may be interchanged with the others or may be used in combination with two or more of these ingredients, or with (or substituted by) other ingredients known to a person of ordinary skill that would provide the same characteristics and features for this category in the system. Further detail on this category is found in Table 7.

Rice contains gluconic acid, an organic acid used to form glucono-delta-lactone, a natural leavening agent. Rice also contributes to the improved texture of meat substitute food products such as burgers and burger mixes. In some embodiments, rice is provided to the system as a finely ground powder. In other embodiments, it may be mixed with water, plant-derived liquid or other liquid to form a liquid, gel or other alternatives, forming the system suitable for mixing and storing, freezing and/or drying. Rice promotes the ayurvedic properties of Rasa: Madhura (Sweet) Guna: Laghu (Light), Sulakshana (Smooth), Viraya: Hima (cooling), Vipaka: Madhura (Sweet).

In the disclosed embodiments the amount of cereal sources (one or more of rice, sorghum, millet, and/or a substitute with the same or similar properties and functionalities as these ingredients) as a percent of the leavening agent replacement system weight ranges from between about 1 to about 25 percent, between about 1 to about 3 percent, between about 3 to about 5 percent, between about 5 to about 7 percent, between about 5 to about 10 percent, between about 10 to about 15 percent, between about 5 to about 15 percent, between about 8 and about 17 percent, between about 10 to about 15 percent, between about 12 to about 17 percent, between about 15 to about 20 percent, and between about 18 to about 25 percent.

The single ingredient or combinations of plant-derived fibers (high water holding capacity), natural fruit acid sources (pear, peach, etc. acid aspect of the leavening agent agent), fruit pectin sources (water retaining capacity and leavening agents), cereal sources (texturizers and natural leavening agents) and plant-derived starches (texturizing agents) along with their Ayurvedic properties (as shown in Table 4), results in a plant only leavening agent replacement system that may be used in whole or part in any variety of food products, the primary example of the disclosed embodiments for Traditional Burger Products and other burger products. Alone or in combination as a leavening agent replacement system, the previously described ingredient categories are effective and natural components in the leavening agent replacement system for burger products, baked products or other food product categories in an amount of about 0.5 percent to up to 10 percent or more by weight of the food product, depending on the type of food product and the replacement ingredients needed or desired. Table 3 above shows preferred ranges percentages as a function of a plant-only burger product weight for the leavening agent replacement system, as well as for other replacement systems and categories of other replacement ingredient combinations.

TABLE 3
Plant-only leavening agent replacement system categories of ingredients and their properties

| | | Compounds | | |
|---|---|---|---|---|
| | | responsible for | | |
| Category / | | the | Physicochemical | Ayurvedic |
| Ingredient | Functionality | functionality | properties | properties |
| Plant-derived | Psyllium husk | Hemicellulose | Water binding | Rasa (Taste): |
| fiber source(s) | may be used to | in psyllium | capacity: 48.29 ± | Madhura |
| (one or more of | retain moisture | husk. | 2.77g H2O/g | (sweet) |
| psyllium husk, | in meat and | Hemicellulose | db | Guna: Guru |
| chia, bamboo, | meat imitation | has a xylan | | (Heavy) |
| and/or | food products. It | backbone, | | Viraya: Hima |
| substitute(s) | increases | associated with | | (cool) |
| exhibiting the | cooking yield | rhamnose, | | Vipaka: |
| same or similar | and decreases | arabinose, and | | Madhura |
| properties and | the shrinkage. | galacturonic | | |
| functionalities | | acid units | | |
| etc.) | | (arabinoxylans) | | |
| Fruit/drupe acid | Dried plums | Ingredients that | Moisture | Rasa: |
| source(s) (one | contain about | provide an | content: 0.014 | Madhura(Sweet) |
| or more of | 2% naturally | acidic | and 0.067 kg | Kashya |
| plums, apricots, | occurring malic | component | H2O · kg−1 dm | (Astringent) |
| peaches, and/or | acid, which is a | contribute to | Porosity: | Guna Guru |
| substitute(s) | natural | increasing | Porosity was | (Heavy) |
| exhibiting the | component of | volume | found higher | Virya: Ushna |
| same or similar | chemical | (raising) and | in the dried | (heat) |
| properties and | leavening | tenderizing a | plum powders | Vipaka: |
| functionalities | systems. | food product | processed by | Madhura |
| etc.) | | (e.g., malic | freeze drying | (Sweet) |
| | | acid) | | |
| Plant-derived | Faba beans can | Proteins and | Faba bean flour: Moisture | Rasa: |
| starch source(s). | serve as a | polysaccharides | %-12.2 peak | Kashya(Astrin |
| (one or more of | protein and | interact to retain | viscosity, | gent) |
| faba beans, rice | fiber substitute | water and fat | breakdown | Guna: Guru |
| flour, potato | in meat | | viscosity, trough | (heavy), |
| flour, tapioca | substitute food | | viscosity, and | Ruksha (dry), |
| starch and/or | products, | | final viscosity | Vipaka: |
| any substitute(s) | such as plant- | | of 3,524, 1,247, | Kashaya |
| exhibiting the | only burgers. | | 2,277, and 4,814 | (Astringent) |
| same or similar | Faba beans | | cP, respectively, | |
| properties and | lower cooking | | Swelling powe- | |
| functionalities | loss and | | 12.67 g/g | |
| etc.) | shrinkage, | | | |
| | improve texture, | | | |
| | maintain flavor | | | |
| | and quality | | | |
| | through frozen | | | |
| | storage | | | |
| Fruit pectin | Apple pectin | Pectin and | pH: (Uncooked) - | Rasa: Madhura |
| source(s) (one | improves | soluble dietary | 5.53-6.68 | (sweet), |
| or more of | emulsion | fiber | (Cooked) - | Astringent |
| apples, bananas, | stability and | | 5.34-5.61 | (kashaya) |
| pears, and/or | water holding | | | Guna: Guru |
| any substitute(s) | capacity, | | | (Heavy) |
| exhibiting the | improving | | | Viraya: Sheeta |
| same or similar | cooking yield, | | | (Cold) |
| properties and | thickness and | | | Vipaka: |
| functionalities | firmness in food | | | Madhura |
| etc.) | products such as | | | (Sweet) |
| | nuggets, | | | |
| | sausages and | | | |
| | patties. Soluble | | | |
| | fibers provide | | | |
| | structural | | | |
| | integrity and | | | |
| | stability to food | | | |
| | products. | | | |
| Cereal source(s) | Rice contains | Glucono-delta- | Moisture % 10 | Rasa: Madhura |
| (one or more of | gluconic acid, | lactone | swelling | (Sweet) |
| rice, sorghum, | an organic acid | | power 8.65% | Guna: Laghu |
| millet, and/or | used to form | | maximum | (light), |
| substitute(s) | glucono-delta- | | viscosity (3521 | Shlakshana |
| exhibiting the | lactone, a | | cp) | (smooth) |
| same or similar | natural | | gelatinization | Viraya: |
| properties and | leavening agent | | temp- 62 to 72 | Hima(cooling) |
| functionalities | in food | | C. | Vipaka: |
| etc.) | | | | Madhura |
| | | | | (Sweet) |

Table 4 below provides an overview of the typical formulation of a commercially available, meat-based burger, including preservatives and other chemical additives.

TABLE 4
Typical formulation for commercially available meat-based burgers

| Meat-based | Weight percent | |
|---|---|---|
| Ingredient/category | of burger | Function |
| Beef/Pork | 60-70 | Meat-based protein and fat source |
| Water | 10 | Moisture |
| Beef Fat | 15-20 | Animal fat source |
| Soy Protein | 10-15 | Protein source |
| Salt | 10-15 | Flavor |
| Caramel color | 5-15 | Colorant |
| Sodium polyphosphates | 2-4 | Stabilizer, meat curer |
| Maltodextrin | 0.25-0.75 | Fat replacer, shelf life extender |
| Cochineal carmine | 5-15 | Colorant |
| Monosodium glutamate | 0.1-0.8 | Flavoring agent |
| Onion | 5-10 | Preservative, flavor enhancer |
| Garlic | 5-10 | Preservative, flavor enhancer |
| Cumin | 1-5 | Preservative, flavor enhancer |
| Sodium erythorbate | 0.5-0.7 | Cure accelerator |
| Natural beef/pork flavors | 1-2 | Flavor |
| Sodium citrate | 2-3 | Acidity regulator |
| Disodium inosinate | 0.1-0.3 | Flavor enhancer |
| Sodium guanylate | 0.1-0.3 | Flavor enhancer |
| Black pepper | 1-5 | Flavor enhancer |
| Capsicum | 1-5 | Flavor enhancer |
| Soybean | 10-40 | Textured vegetable protein |
| Nisin | 0.01-0.05 | Preservative |
| Nitrites and Nitrates | 1-5 | Taste, colorant, antimicrobial |
| | | Moisture retention, stabilizer, shrinkage |
| Phosphate Salts | 0.1-0.5 | reducer, flavor enhancer, colorant |
| Tertiary butylhydroquinone | 0.02-0.03 | Antioxidant |
| (TBHQ) | | |

In some embodiments, the modified starch replacement system when added to meat-based products within the Traditional Burger Products such as in the example above, replaces some or all of the artificial stabilizers, proteins, and/or flavoring agents and enhancers.

Table 5 below, similarly provides an overview of the typical formulation of a commercially available, plant-based burger or burger mix, with numerous chemical additives. Although a somewhat improved profile compared to the profile of the formulation of the meat-based burger shown in Table 4, it can be improved for certain consumer diets with the use of plant-only replacements such as the leavening agent replacement system. The leavening agent replacement system may also be used to improve the quality of meat-based food products intended for pets and other animals.

TABLE 5
Typical formulation for commercially available, plant-based burgers

| Plant-based Burger | Weight Percent | |
|---|---|---|
| Ingredient/Category | of Product | Function |
| Pea protein isolate | 70-80 | Protein |
| Water | Variable | Moisture |
| Expeller-pressed canola oil | 2-5 | Fat source |
| Refined coconut oil | 20-25 | Fat source |
| Cellulose from bamboo | ≤2 | Texturizer |
| Methylcellulose | 0.1-2 | Thickener, emulsifier |
| Potato starch | 2-4 | Thickener |
| Flavoring agents | 10-15 | Flavor |
| Maltodextrin | 0.2-0.9 | Fat replacer, shelf life extender |
| Yeast extract | 1-2 | Flavor enhancer |
| Salt | 2-5 | Flavor |
| Sunflower oil | 8-10 | Fat source |
| Vegetable glycerin | 5-15 | Sweetener |
| Dried yeast | 1-3 | Flavoring agent |
| Gum arabic, konjac gum, | | Emulsifier, stabilizer, thickener, |
| xanthan gum, Locust bean | | foaming agent, texturizer, moisture |
| gum, carrageenan | 0.1-1 | retention. |
| Citrus extract (to | | Antimicrobial, preservative |
| protect quality) | 1-3 | |
| Ascorbic acid (to maintain | | Color retention |
| color) | 0.1-1 | |
| Beet juice extract (for color) | 5-10 | Colorant |
| Acetic acid | 0.5-2 | Shelf life extender |
| Succinic acid | 1-2 | Acidulant/flavoring agent |
| Modified food starch | 5-15 | Texturizer |
| Annatto (for color) | 2-5 | Colorant |

In some embodiments, the modified starch replacement system when added to plant-only burger products such as in the example above, replaces some or all of the yeast extract and dried yeast.

TABLE 6
Comparison of formulations of plant-based burgers and burger mixes versus
commercially available plant-only burgers and burger mixes, indicating
relevant replacements for traditional additives in plant-based burger

| Example Formulation of | |
|---|---|
| Commercially Available Plant- | |
| based Burger Products with | |
| Traditional Additives, | Plant-only Formulation for Burger Products |
| Including | Replacing Commercially Available Leavening |
| Leavening agents | agents |
| Pea protein isolate | One or more protein source(s) (peas, lupine, |
| | mushrooms, quinoa, chickpea, etc.) |
| Water | Water (from plant or external source) |
| Expeller-pressed canola oil | One or more oils (sunflower, coconut, flaxseed and rice |
| Refined coconut oil | bran) containing high levels of MUFAs, omega-3 fatty |
| Sunflower oil | acids, & MCTs |
| Cellulose from bamboo | Plant-only methyl cellulose (MC) replacement system |
| Methylcellulose | (blend of five categories of ingredients: protein, fibers |
| | from whole grains; fibers from fruits, seeds and |
| | vegetables, vegetable binding agents and starches as |
| | shown in Tables 1 & 2) (0.5-30% weight of the plant- |
| | only burger product, depending on whether water or other |
| | liquid is included in the burger product or other mix). |
| Annatto (for color) | Plant-only color and flavorants, nutraceuticals |
| | (one or more of cumin, coriander, paprika, black |
| Natural flavor | pepper, etc.) |
| | Plant-only umami flavor replacement system (one or more |
| | of shiitake and other mushrooms, tomatoes, garlic, lotus |
| | stalk, onions, mineral salts, etc.) |
| Maltodextrin | Plant-only shelf-life extender |
| | (one or more of garlic, black pepper, oregano, bay |
| | leaf etc.) |
| Yeast extract | Flavor enhancer (one or more of nutritional yeast, |
| Vegetable glycerin | cashews etc.) |
| Dried Yeast | Plant-only leavening agent replacement system |
| | (combination of ingredients from five categories of Table |
| | 1, including one or more of psyllium husk, apple |
| | pomace, |
| | rice starch, faba beans, plum powder, etc.) |
| Salt | Mineral Salts (Himalayan pink salt, sea salt) |
| Gum arabic, konjac gum, xanthan | Plant-only gums and carrageenan replacement |
| gum, locust bean gum, carrageenan | system (one or more of quince seed, apple, mesquite, |
| | almond, etc.) |
| Citrus extract (Retain/preserve | Plant-only leghemoglobin (one or more of beets, red |
| quality) | radish, etc.) |
| Ascorbic acid (to maintain color) | |
| Beet juice extract (for color) | Plant -only shelf life extender (one or more of garlic, black |
| Acetic acid | pepper, onion etc.) |
| Succinic acid | Plant-only flavor enhancer (one or more of paprika, black |
| | pepper, beet juice, etc.) |
| Modified food starch | Plant-only modified starches replacement (one or more |
| Potato starch | of tapioca, faba bean, sorghum, quinoa, etc.) |

Table 7 below provides a detailed description of the functionality of the various plant-only replacement systems and other categories of ingredients specific to plant-only burger products, as determined by the machine learning system described above.

### Functionality of Replacement Systems for Burger Products

The unique combination of essential ingredients in each plant-only replacement system, including individual ingredients or combinations of ingredients within each category of the system provides certain functionalities necessary for quality, plant-only burger products, as shown in the following table.

TABLE 7
Functionalities Provided by Plant-Only Replacements in Burger Products

| | Plant-only | |
|---|---|---|
| | Burger Product | Plant-Only Ingredients, Ingredient |
| | Essential | Combinations or Replacement Systems |
| | Ingredients and | Enabling Functionality within the Burger |
| Function | Combinations | Product Composition |
| Emulsifier | One or more oils | Sunflower oil is primarily (85%) unsaturated |
| | providing high | fatty acids comprising 14-43% oleic acid and |
| | levels of MUFAs, | 44-75% linoleic acid, the latter, which results |
| | omega 3 fatty | in the oil's lower freezing point, and |
| | acids, & MCTs | contributes to the lower freezing points of |
| | (sunflower oil, | products in which sunflower oil is added. |
| | coconut oil, | Coconut oil, in contrast, is ~87% saturated |
| | flaxseed oil, rice | fatty acids, lauric acid accounting for ~49% of |
| | bran oil, or other | the saturated fats. Other saturated fatty acids |
| | oil substitute | include myristic, palmitic, stearic, oleic, capric |
| | exhibiting the | and caprylic acids. |
| | same or similar | Flaxseed comprises ~35-45% oil and 20-30% |
| | properties and | protein. The oily portion consists of 9-10% |
| | functionality) | saturated fatty acids (palmitic and stearic), ~20% |
| | | monounsaturated fatty acids (mainly oleic |
| | | acid), and more than 70% alpha-linolenic fatty |
| | | acids acid. |
| | | Rice bran oil consists of ~74% unsaturated |
| | | fatty acids (~30% linoleic acid, ~44% oleic |
| | | acid), and the remaining ~23% are saturated |
| | | fatty acids. |
| Thickening | Thickeners and | Chickpea fractions (starch, proteins) function |
| agents / | binding agents (one | as binders and are also a protein source (72- |
| binding agent | or more of | 85% are globulins and albumin. Protein |
| | chickpeas, oat fiber, | matrices formed have the ability to hold water |
| | passion fruit, | and fat. Their binding properties are also |
| | aquafaba, sugar | attributable to water soluble and insoluble |
| | beet pectin, and/or | carbohydrates: cellulose, starch and |
| | substitute(s) with | hemicellulose. Soluble carbohydrates have |
| | the same or similar | higher water binding capacities, and water |
| | functionality and | soluble- and insoluble polysaccharides also |
| | properties) | absorb oil. |
| | | Oat fiber retains water, decreases cooking |
| | | losses and has neutral flavor. Oats have a fiber |
| | | type of β-glucan, a soluble fiber accounting to |
| | | 4%. It depicts functional properties as a |
| | | potential binding agent. Oat fiber provides the |
| | | flavor, texture and mouthfeel of fat. Passion |
| | | fruit has a high proportion (52%) of insoluble |
| | | dietary fiber (cellulose, hemicellulose, and |
| | | pectin), which contributes to strong fat and |
| | | water retaining abilities. The fruit contains |
| | | moderate length cellulose fibers, contributing |
| | | to a moderate ability to retain fat. Cellulose |
| | | interlinks with hemicellulose and forming a |
| | | fiber net, increasing the surface area of |
| | | individual fibers, and contributing their water |
| | | and oil retention properties. |
| Texturizer / | Modified starch | Tapioca starch is an excellent thickener, binder, |
| gelling agent | replacement | texturizer and stabilizer. Sometimes called |
| | system (one or | tapioca flour, this starch originates from the |
| | more of tapioca | cassava plant. |
| | starch, faba bean, | Gelatinized (tapioca) starch can hold a |
| | sorghum starch, | significant amount of water, which helps |
| | quinoa starch, rice | improve the texture of many food products, |
| | starch or substitute | including burgers and burger mixes. |
| | exhibiting the same | The faba bean protein is glossy and sticky, and |
| | or similar | is an important emulsifier, foam stabilizer, and |
| | functionality and | contributes to gel formation. Its protein |
| | properties) | constituents include globulin and albumin |
| | | accounting for ~25-30% of its content; these |
| | | proteins do not contribute as much as the other |
| | | constituents to the gelling capacity. |
| | | The quinoa starch is relatively low in amylose |
| | | content (e.g., 11%), and has very small |
| | | granules (1 to 3 μm) The starch has unique |
| | | properties such as low pasting temperature, high |
| | | freeze-thaw stability, and water holding |
| | | capacity. The protein from quinoa flour helps |
| | | provide structure and shape to the system. The |
| | | protein and starch both contribute to the gelling |
| | | property. |
| | | Sorghum starch consists mainly amylopectin |
| | | and amylose. While heating, the gelatinization |
| | | of starch occurs due to hydrogen bonds being |
| | | broken within the starch granule due to water |
| | | influx, which results in granular swelling, |
| | | increasing viscosity, which thickens and |
| | | texturizes the food product. |
| Shelf-life | Plant only shelf-life | Garlic (Allium sativum) is one of the |
| extender; | extenders (any one | commonly used plants to enhance flavor. It |
| preservative, | or more of herbs | produces a wide spectrum of actions which |
| flavoring | and spices, | have led to its use as an antibacterial, |
| agent, | including garlic | antifungal, and antioxidant agent. The presence |
| stabilizer | extract, Himalayan | of allicin, a sulfur-containing compound, is |
| | pink salt; black | responsible for the antimicrobial effects. |
| | pepper, oregano, | Himalayan pink salt contains substantially |
| | bay laurel and/or | higher levels of calcium, iron, magnesium, |
| | any substitute(s) | manganese, potassium, aluminum, barium, |
| | that exhibit the | silicon, and sulfur, but lower levels of sodium |
| | same or similar | compared to the white table salt |
| | functionality and | Black pepper, Piper nigrum, has piperine in |
| | properties) | higher amounts that enables antimicrobial |
| | | activity. Terpenes and flavonoids also |
| | | contribute to its activity. The essential oil |
| | | content in black pepper mainly consists of |
| | | caryophyllene (30.3%) and limonene |
| | | (12.12%), both of which also contribute to its |
| | | antimicrobial activity. |
| | | Oregano, Origanum vulgare, along with its |
| | | flavor imparting action, contributes to |
| | | antimicrobial and antioxidant properties. The |
| | | major components of oregano essential oil are |
| | | carvacrol, β-fenchyl alcohol, thymol, and γ- |
| | | terpinen. These compounds have a free radical |
| | | scavenging effect contributing to enhanced |
| | | shelf life. |
| | | Bay leaf contains 1.3% essential oils that |
| | | contribute to both flavor and shelf life |
| | | enhancement. These oils include primarily |
| | | eucalyptol (45%) but also other terpenes |
| | | (~12%), terpinyl acetate (8-12%), |
| | | sesquiterpenes (3-4%), methyl eugenol (3%), |
| | | and smaller amounts of other α- and β-pinenes, |
| | | phellandrene, linalool, geraniol, terpineol and |
| | | lauric acid. These compounds exhibit radical |
| | | scavenging and antimicrobial activity. |
| Flavoring | Umami flavor | Meat and other animal-based products can be |
| agent/ | source(s) (one or | replaced in some food products with one or |
| umami flavor | more of shitake and | more types of mushrooms without |
| | other mushroom | compromising flavor, and can improve |
| | types, onions, | nutritional quality by reducing sodium, |
| | tomatoes, garlic, | calories, saturated fat, and cholesterol content. |
| | lotus stalk, salt, | Mushrooms impart an “umami” flavor because |
| | and/or any | of their flavor-enhancing compounds, most |
| | substitute(s) for | noticeably the eight carbon (C8) volatile |
| | these exhibiting the | compounds. Among all C8 compounds, the |
| | same or similar | most important for mushroom flavor are oct-1- |
| | functionality and | en-3-ol, octan-3-ol, octan-3-on and oct-1-en-3- |
| | properties) | on. |
| | | Onion (Allium cepa L.) contains high levels of |
| | | flavonoids that enhance the flavor of food |
| | | products. Onions contribute to the umami flavor |
| | | of food with their high glutamic acid content |
| | | (~25 to 50 mg/100 g). |
| | | Tomatoes impart a unique flavor, the result of |
| | | a complex mix and interaction among sugars, |
| | | acids, and volatile compounds. They also are |
| | | high in glutamate (~250 mg/100 g). |
| Flavorants, | One or more | Paprika oleoresin contains a number of |
| flavor | flavorants, flavor | Carotenoids and pigments, including, among |
| enhancers, | enhancers, | others, capsanthin and capsorubin, which are |
| nutraceutical | nutraceuticals (one | strong antioxidants. Paprika is low in capsaicin, |
| | or more of herbs | the pungent (hot) compound found in red |
| | and spices such as | peppers. Methoxypyrazines” in paprika are |
| | cumin, paprika, | responsible for its vegetative flavor. The |
| | coriander, black | sweetness of paprika comes from a sugar |
| | pepper, onion, or a | content (up to 6%). Paprika has important |
| | substitute(s) that | bioactive compounds such as carotenoids, |
| | exhibit the same or | quercetin glycosides, and luteolin, all of which |
| | similar functionality | exhibit high antioxidant activity. |
| | and properties) | Onions (Allium cepa L.) contain phytonutrients |
| | | such as: flavonoids, fructooligosaccharides |
| | | (FOS), thiosulfide and other sulfur compounds, |
| | | which are recognized as important elements of |
| | | highly nutritional molecules. Quercetin is the |
| | | main flavonoid present in onions, exhibiting |
| | | antioxidant and antimicrobial properties. |
| | | Black pepper (P. nigrum) contains numerous |
| | | flavor compounds and has antimicrobial and |
| | | antioxidant properties. The primary volatile |
| | | flavor compounds include terpenes: |
| | | monoterpene hydrocarbons (59.2-80.1%) and |
| | | sesquiterpene hydrocarbons (17.0-37.7%) |
| | | while oxygenated terpenoids accounted for |
| | | about 1.3-2.7%. Key odorants of black pepper |
| | | are α- and β-pinene, myrcene, a-phellandrene, |
| | | limonene, linalool, methyl propanal, 2- and 3- |
| | | methylbutanal, butyric acid, germacrene, and 3- |
| | | methylbutyric acid. The spiciness of black |
| | | pepper comes from Piperine. Germacrene is |
| | | potent, spicy, warm and has a sweet aroma. In |
| | | contrast, limonene is sweet, orange, citrus and |
| | | terpy. The essential oil content in black pepper |
| | | mainly consists of caryophyllene (30.3%) and |
| | | limonene (12.12%) also contribute to |
| | | antioxidant activity. |
| | | Cumin is a seed spice belonging to the family |
| | | Umbelliferae. Cumin and products flavored by |
| | | cumin are used in food products and |
| | | perfumery. Cumin contains ~2.3 to 4.8% of |
| | | volatile oils. The characteristic odor of cumin |
| | | is mainly due to the aldehydes present in the |
| | | seeds, namely, cuminaldehyde (45-50%), p- |
| | | menth-3-en-7-al and p-menth-1,3-dien-7-al. |
| | | Other major compounds present in cumin |
| | | contributing its distinct flavor include: cuminal |
| | | (8-17%), β-pinene (22-27%), β-myrcene (1.3 |
| | | 1.75%), ρ-cymene (23-39%), γ-terpinene (11- |
| | | 27%), and p-mentha-1,4-dien-7-ol (1.0-5.5%). |
| | | Coriander, Coriandrum sativum, has a |
| | | characteristic flavor is due to terpenes. The |
| | | essential oils present in oil glands in the |
| | | mericarp and the linalool, with its floral and |
| | | pleasant scents also contribute to flavor |
| | | enhancement. |
| | | Phenolics compounds present in the coriander |
| | | seeds such as gallic acid, caffeic acid, ellagic |
| | | acid, quercetin, kaempferol contribute to the |
| | | antioxidant activity. |
| Thickener, | MC replacement | Pea fiber contains insoluble fibers and higher |
| Binding agent, | system: ingredients | protein content, which contribute to its ability to |
| Stabilizer | from all five | hold water. The combination of protein and |
| | categories (proteins; | fiber also leads to the higher oil absorbing |
| | fibers from whole | capacity. Peas contain a high amylose starch |
| | grains, fruits, seeds | content (25-29%) that enables it to bind water |
| | and vegetables; | and oil. |
| | starches; and | Oat fibers retain water, decreases cooking loss, |
| | vegetable binders) | and it has a neutral flavor. Oats contain 4% (by |
| | and/or any | weight) of β-glucan, a soluble fiber with |
| | substitute(s) that | potential binding abilities. Oat fiber provides |
| | exhibit the same or | flavor, texture, and mouthfeel of fat. In addition, |
| | similar properties | B-glucan also contains hydrocolloids that |
| | and functionalities | provide emulsion stability, modifying the |
| | | gelation process and increasing viscosity. β - |
| | | glucan forms a porous network in a protein-gel |
| | | matrix, e.g., holding fat globules in the burger |
| | | system. |
| | | Chickpeas contain starch and protein, and act |
| | | as binder and stabilizer. Chickpea proteins |
| | | include globulins and albumin, which act as |
| | | binding proteins; these binding proteins |
| | | constitute 72-85% of the weight of the |
| | | chickpea, and function as thickeners and |
| | | binders by forming protein matrices that hold |
| | | water and fat. |
| | | Quinoa starch is relatively low (e.g., 11%) in |
| | | amylose and appears as small granules (1 to 3 |
| | | um). Quinoa starch has unique properties: low |
| | | pasting temperature, high freeze-thaw stability, |
| | | and water holding capacity. The Quinoa starch |
| | | granules are small, polygonal, and in the range |
| | | of 0.5-3 μm; they function as a stabilizer for |
| | | creating pickering emulsions. The proteins from |
| | | quinoa flour help provide structure and shape to |
| | | the food product. |
| Hydro | Gums and | The main fraction of quince seed gum are |
| Colloids- | carrageenan | high-molecular-weight polysaccharides, the |
| gelling, | replacement | most abundant among them which is d-Xylan, |
| emulsifier, | system (one or | with many glucuronic acid residues. The |
| stabilizer, | more of quince | presence of proteins in quince seed gum |
| sequestrant | seed, apple, | (2.2%) affects the interfacial tension at the oil- |
| | mesquite, almond, | water interface, and contributes to its ability to |
| | and/or substitute(s) | act as an emulsifier. |
| | that exhibit the | Almond gum is mainly composed of 92.36% |
| | same or similar | of polysaccharides (dry weight basis) with the |
| | properties and | major sugar composition comprising: |
| | functionality) | arabinose (46.83%), galactose (35.49%) and |
| | | uronic acid (5.97%). It also contains a small |
| | | amount of protein (2.45%) |
| | | Mesquite gum is a complex carbohydrate and |
| | | is comprised of D-galactose, L-arabinose, D- |
| | | glucuronate, D-mannose and D-xylose. |
| | | Apple pomace pectin is a low methyl |
| | | cellulose-containing pectin, it forms a thermo- |
| | | irreversible gel, remaining in a gel consistency |
| | | even at high temperatures that would normally |
| | | melt pectin. Pectin's aid in the formation of |
| | | smaller droplet size emulsions, showing higher |
| | | stability and forming a gel-like consistency. The |
| | | action of the insoluble fibers in pectin is to |
| | | maintain the stability in emulsion through |
| | | pickering mechanism and through network |
| | | formation in the continuous phase; this may be |
| | | favored by stabilization of proteins and pectin |
| | | in the soluble fraction. |
| Flavoring | Flavor enhancer, | Nutritional yeast is a food additive made from |
| agent | nutritional yeast | a single-celled organism, Saccharomyces |
| | (one or more of | cerevisiae, a member of the fungi kingdom. |
| | nutritional yeast, | This yeast is grown on molasses and then |
| | cashews and/or any | harvested, washed, and dried with heat to kill |
| | substitute(s) for | or deactivate it. |
| | either one that | Cashews contain esters (methyl 3-methyl |
| | exhibits the same or | butanoate, ethyl 3-methyl butanoate, methyl |
| | similar functionality | butanoate, ethyl butanoate, ethyl trans-2- |
| | and properties) | butenoate and methyl 3-methyl pentanoate) |
| | | which impart a sweet, fruity taste and aroma. |
| Leavening | Leavening agent | Apple cider vinegar is the fermented juice of |
| agent(s) | replacement | crushed apples, containing acetic acid, which |
| | system (ingredients | contributes to the leavening action in food |
| | from all five | products. |
| | categories of Table | Dried plums contain about 2% naturally |
| | 1, including one or | occurring malic acid, which serves as the |
| | more of plum | natural acid component of chemical leavening |
| | powder, apple cider | systems. Dried plums can also act as a natural |
| | vinegar, vegan | preservative, inhibiting microbial spoilage. |
| | buttermilk, and/or | Vegan buttermilk is made by combining |
| | any substitute(s) | almond milk with acidulants. The high fat |
| | that exhibit the | content combined with acids result in curdling. |
| | same or similar | |
| | functionality and | |
| | properties) | |
| Lipid | Lipid peroxidation | Black pepper (P. nigrum) with piperine as an |
| peroxidation | inhibitors (one or | active ingredient, holds rich phytochemistry |
| inhibitor, | more of black | that also includes volatile oil, oleoresins, and |
| antioxidant, | pepper, bay leaf, | alkaloids. Black pepper oleoresins impart taste |
| flavor enhancer | cumin, and/or any | and exhibit antioxidant properties. They are |
| | substitute(s) that | also used as a colorant and a food preservative |
| | exhibit the same or | because of their antimicrobial properties. β- |
| | similar functionality | Caryophyllene, limonene, β-pinene, α-pinene, |
| | and properties) | δ-3-carene, sabinene, and myrcene are the |
| | | main components of this oil. |
| | | Bay leaves showed radical scavenging activity |
| | | due to the presence of sesquiterpene lactones, |
| | | alkaloids, and glycosylated flavonoids. The |
| | | kaempferol C-glycoside is the major |
| | | contributor to antioxidant properties. |
| | | Cumin's antioxidant activity is correlated with |
| | | the presence of high polyphenols, mainly |
| | | flavonoids. The essential oils present - |
| | | carvacrol, anethole, and terpineol - also |
| | | contribute to the function of radical |
| | | scavenging. |
| Color | One or more | Leghaemoglobin is a protein that binds oxygen |
| retention, | sources of | and is found in the root nodules of leguminous |
| coloring agent, | leghaemoglobin | plants; it is often used as an ingredient in some |
| nitrite | (one or more of | plant-based meat substitutes. |
| replacement | beets, red radishes | Red beet - B. vulgaris - is one of the top ten |
| | and/or any | most potent antioxidant-rich vegetables. |
| | substitute(s) that | Betalains (including betanin/betanidin) exhibit |
| | exhibit the same or | high antioxidant activity. Red radish and beet |
| | similar functionality | powders exhibit antioxidant activity and are |
| | and properties) | high in nitrates. Radish powder in particular |
| | | prevents meats and meat substitutes from |
| | | changing color. |

### Preparation of the Leavening Agent Replacement System or its Component Categories

At step 102, the method includes mixing a) 15-20% by weight of a plant-derived fiber source, b) 10-25% by weight of a natural fruit acid source, c) 15-20% by weight of a plant-derived starch source, d) 15-20% by weight of a fruit pectin source, and e) 5-15% by weight of a cereal source at a temperature between 60 degrees Celsius and 105 degrees Celsius for about 30 seconds to one minute to form a homogeneous mixture of the plant-only leavening agent replacement system.

In one embodiment the leavening agent replacement system, or any of its individual categories, individual ingredients or combinations of ingredients within each category, can be prepared by combining and mixing the dried, powdered ingredients selected from Table 2 in the relative amounts identified as preferred, essential ingredients of the system to be used in a desired food product. In some embodiments the leavening agent replacement system may be in the form of a liquid or gel due to the addition of water or other plant-derived liquid to one or more of the ingredients or categories of ingredients before mixing, such as, for example, aquafaba in liquid form. In some embodiments the leavening agent replacement system is mixed with additional water or plant-derived liquid, then dried and powdered and stored. In some embodiments the leavening agent replacement system is prepared in liquid form and freeze dried. In certain embodiments, the leavening agent replacement system may be prepared and stored in a liquid or moist form (as in a gel or dough). In certain other embodiments the leavening agent replacement system may be prepared as a liquid, gel or in dried form and then frozen for storage. In other embodiments, each of the categories of ingredients, individual ingredients, or combinations of ingredients within each of the categories of the leavening agent replacement system, whether in liquid, gel, dried or other form, are mixed individually directly into and become a part of another food product rather than being combined as the complete replacement system prior to incorporation into another food product.

In some embodiments, the leavening agent replacement system stands alone as a plant-only food product. In other embodiments, the leavening agent replacement system is a component of another food product, such as a plant-only burger product, or other imitation meat product. In certain embodiments, the leavening agent replacement system is a component of a baked good food product, or a frozen burger or burger mix, which may then be incorporated into other food products. In still other embodiments the food product is one of several components used to create final food product. In other embodiments, the food product is a Traditional Burger Product. In some embodiments, the ingredients of Table 2 may be selected and combined in other relative amounts (a variety of ranges) identified for each of the five leavening agent replacement system categories discussed infra to achieve the required functional characteristics most closely resembling those of leavening agent in a variety of food products, including, e.g., Traditional Burger Products.

In some embodiments, psyllium husk powder is used as the Plant-derived fiber source. Plantago ovata seed husk is dried out and ground for five minutes in an ultra centrifugal mill with the rotor. The powder is then separated using the 0.5 mm sieve set.

Sifted powder is collected. Water Holding Capacity (WHC) is caused by a network of mainly insoluble, non-cellulosic cell wall polysaccharides (CWPs). oat fiber has a WHC of 6.0 g water/g sample, Pea fiber has a WHC of 8.35±0.18 g water/g sample, Psyllium husk powder has a WHC of 33.71±0.10 g water/g sample, Soybean fiber has a WHC of 3.79 g water/g sample, Chia seed flour has a WHC of 12.42 g water/g sample, Bamboo fiber has a WHC of 9.34 g water/g dry solids. Hemicelluloses is a cell wall polysaccharide that can bind strongly to cellulose microfibrils by hydrogen bonds. Pea fiber has 15.10±0.04% hemicellulose content, Psyllium husk powder has 70% soluble fiber content and 30% insoluble fiber content (hemicellulose), Bamboo fiber has 12.94% hemicellulose content and Soy fiber have 10-25% hemicellulose content.

In some embodiments, Plums (prunes) powder is used as the natural fruit acid source. In a vacuum drier, the plums are dried by vacuum. Plums are put in the drying chamber, where they are dried at 60° C. and 300 Pa of pressure. The dried plums are ground for 30 seconds at room temperature. The Fruit acid is responsible for acidifying, maximum height and specific volume to the overall structure. The addition of the acids with proper concentrations could exert a positive effect on the volume. Organic acids promote yeast activity and contribute to the increase in gas production capability. 0.3% Malic acid from prunes powder leads to 67.40% of gas retention i.e. the percentage of retention volume to total volume.

In some embodiments, Faba beans starch powder is used as the plant-derived starch source. With a mesh size of 0.5 mm, an ultra-centrifugal mill is used to dehull and grind the faba beans. The centrifugation step's pellet is re-dispersed in distilled water, the pH is raised to 9.5, and the mixture is agitated for 24 hours at room temperature to extract the starch. After standing at 4° C. for 24 hours without being stirred, the mixture is centrifuged (3700 g, 20° C., 5 min). The pellet is re-dispersed in distilled water after the supernatant is discarded. The resulting pellet is dissolved in distilled water and passed through a 70 m nylon filter to separate the starch from the fiber. Following filtration, the starch-rich filtrate is dried at 40° C. for 48 hours, and the filter cake is freeze-dried. WHC is a measure of hydration capacity because the determination is a weight measure of swollen starch granules and their occluded water. Food eating quality is often connected with the retention of water in the swollen starch granules. Amylose gives the gel strength and the amylopectin gives high viscosity. Amylose content for tapioca is ˜17%, and amylopectin 82%. Peak viscosity is the indicator of starch granule swelling and high-value peak viscosity indicates a high capacity for swelling of starch. Starches with high peak viscosity are possible to show high breakdown values, leading to weak gels. So it has to be in a medium range. The high pasting temperature of starches indicates a higher resistance to swelling and rupture.

In some embodiments, Apple pomace powder Fruit pectin source. Apple pomace is obtained from the belt juice pressing. Frozen apple pomace is exposed to drying treatments with forced air drying at 40° C. at 110° C. Using a laboratory mill with a 0.5 mm screen, partially dried pomace is converted into flour. Pectin-rich dietary fiber has high water-holding capacity (WHC) and viscosity so that it can bind water tightly to reduce syneresis. Pectin dissolves in water to give a colloidal solution, which, when dehydrated, forms a solid gel. Hydrogen bonds and hydrophobic interactions bind the individual pectin chains together. High water holding capacity, combined with high fat absorption capacity, indicates good emulsifying properties, facilitating the solubilization or dispersion of two immiscible liquids. Apple pomace includes a WHC of 4.40±0.14 g water/g sample and Emulsion Stability (ES) of 66% when 2% of pomace is added. Jujube pomace includes a WHC of 2.61±0.07 g water/g sample, Redcurrant includes a WHC of 5 g water/g sample, ES of 98%, oil absorption capacity (OAC) of 6.6 g of oil/g of the sample. Strawberry includes a WHC of 5.6 g water/g sample, ES of 80% and OAC of 17 g of oil/g of the sample. Raspberry includes a WHC of 1.4 g water/g sample, ES of 40% and OAC of 8.9 g of oil/g of the sample. Blackberry includes a WHC of 6.6 g water/g sample, ES of 54%, OAC of 11 g of oil/g of sample. Passion fruit peel includes a WHC of 11.59 g water/g sample, OAC of 4.05 g of oil/g of sample.

Orange pomace includes a WHC of 7.57 g water/g sample and OAC of 2.97 g of oil/g of sample.

In some embodiments, Rice powder is used as the cereal source. Rice that has been rinsed and drained is spread out on a cloth for traditional drying before being dry-roasted for three to five minutes, or until it is entirely dry. Before the flour is sieved, dried rice is transferred to a blender and ground into a fine powder. Most of the cereals have organic acids like gluconic acid is used to form glucono-delta-lactone. Like many other cereal organic acids, Gluconic acid or gluconate is used to maintain the cation-anion balance on electrolyte solutions. Hence it is used to adjust the acidity or as a leavening agent in baked goods, processed fruits, and dairy products. It is a good chelator at high pH like 5.

The plant-only leavening agent replacement system functions to replace leavening agents in Traditional Burger Products or plant-only burger products comprises a combination of solely plant- or fungi-sourced ingredients and added water, if any is required for their preparation. The plant-only ingredients and combinations of ingredients selected for the leavening agent replacement system are consistent with the requirements and specifications of achieving the functionalities exhibited by convention leavening agents, when used in food products containing meat substitutes.

Merely for illustration, only representative number/type of graph, chart, block, and sub-block diagrams were shown. Many environments often contain many more block and sub-block diagrams or systems and sub-systems, both in number and type, depending on the purpose for which the environment is designed.

While specific embodiments of the disclosed embodiments have been shown and described in detail to illustrate the inventive principles, it will be understood that the disclosed embodiments may be embodied otherwise without departing from such principles.

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment” and similar language throughout this specification may, but do not necessarily, all refer to the same embodiment.

It should be understood that the figures and/or screen shots illustrated in the attachments highlighting the functionality and advantages of the disclosed embodiments are presented for example purposes only. The disclosed embodiments are sufficiently flexible and configurable, such that it may be utilized in ways other than that shown in the accompanying figures.

It should be understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A plant-only leavening agent replacement system in food products comprising:
a) 15-20% by weight of a plant-derived fiber source, b) 10-25% by weight of a natural fruit acid source, c) 15-20% by weight of a plant-derived starch source, d) 15-20% by weight of a fruit pectin source, and e) 5-15% by weight of a cereal source.

2. The plant-only leavening agent replacement system of claim 1, wherein the plant-derived fiber source is selected from psyllium husks, chia, bamboo, Quinoa fibers, pea fiber, oat fiber, soy fiber, corn fiber, Phaseolus vulgaris flour, chickpea flour or combinations thereof.

3. The plant-only leavening agent replacement system of claim 1, wherein the natural fruit acid source is selected from prunes, peaches, apricots, apples, olives, loquat, sweet cherries, mangoes, Indian gooseberries, nectarines or combinations thereof.

4. The plant-only leavening agent replacement system of claim 1, wherein the plant-derived starch source is selected from Faba beans, potato flour, tapioca starch, rice starch, Jackfruit seed powder, Taro starch, Yam starch, Arrowroot starch, Cassava starch, wheat starch or combinations thereof.

5. The plant-only leavening agent replacement system of claim 1, wherein the fruit pectin source is selected from Apples, bananas, acerola, Jujube pomace, Redcurrant, blackberry, strawberry, orange pomace, dragon fruit peel, raspberry or combinations thereof.

6. The plant-only leavening agent replacement system of claim 1, wherein the cereal source is selected from rice, sorghum, millet, Barley, wheat, maize, oats, rye, amaranth, ragi or combinations thereof.

7. The plant-only leavening agent replacement system of claim 1, wherein the food products comprise meat-based and meat substitute products formed as nuggets, sausages, patties, frozen burger or burger mix, quick breads, cakes, cookies, refrigerated biscuit dough, crackers, biscuits, pastries, pies and prepared cereals.

8. A method of preparing a plant-only leavening agent replacement system in food products, wherein the method comprises:
mixing a) 15-20% by weight of a plant-derived fiber source, b) 10-25% by weight of a natural fruit acid source, c) 15-20% by weight of a plant-derived starch source, d) 15-20% by weight of a fruit pectin source, and e) 5-15% by weight of a cereal source at a temperature between 60 degrees Celsius and 105 degrees Celsius for about 30 seconds to one minute to form a homogeneous mixture of the plant-only leavening agent replacement system.

9. The method of claim 8, wherein the method includes blending the plant-only leavening agent replacement system with a formulation of the food product in a blender or bowl cutter.

10. The method of claim 8, wherein the fiber source, the natural fruit acid source, the starch source, the fruit pectin source and the cereal source are obtained as a dried powder.

11. The method of claim 8, wherein the plant-only leavening agent replacement system is obtained as a gel or dough.

12. The method of claim 8, wherein the plant-derived fiber source is selected from psyllium husks, chia, bamboo, Quinoa fibers, pea fiber, oat fiber, soy fiber, corn fiber, Phaseolus vulgaris flour chickpea flour or combinations thereof.

13. The method of claim 8, wherein the natural fruit acid source is selected from prunes, peaches, apricots, apples, olives, loquat, sweet cherries, mangoes, Indian gooseberries, nectarines or combinations thereof.

14. The method of claim 8, wherein the plant-derived starch source is selected from Faba beans, potato flour, tapioca starch, rice starch, Jackfruit seed powder, Taro starch, Yam starch, Arrowroot starch, Cassava starch, wheat starch or combinations thereof.

15. The method of claim 8, wherein the fruit pectin source is selected from Apples, bananas, acerola, Jujube pomace, Redcurrant, blackberry, strawberry, orange pomace, dragon fruit peel, raspberry or combinations thereof.

16. The method of claim 8, wherein the cereal source is selected from rice, sorghum, millet, Barley, wheat, maize, oats, rye, amaranth, ragi or combinations thereof.

17. The method of claim 8, wherein the food products comprise meat-based and meat substitute products formed as nuggets, sausages, patties, frozen burger or burger mix, quick breads, cakes, cookies, refrigerated biscuit dough, crackers, biscuits, pastries, pies and prepared cereals.

18. The method of claim 8, wherein physical characterization data associated with ingredients of the plant-only leavening agent replacement system comprising the plant-derived fiber source, the natural fruit acid source, the plant-derived starch source, the fruit pectin source and the cereal source is stored in a database, wherein a machine learning model determines a unique combination of ingredients based on the physical characterization data to prepare the plant-only leavening agent replacement system.

19. The method of claim 18, wherein the physical characterization data of the ingredients comprise functional properties that comprise emulsification properties, stabilization properties, gelling properties, fat-replacement properties, Ayurvedic and/or other holistic properties, physicochemical properties that comprise pH, viscosity, moisture content, density, mechanical properties that comprise adhesive strength, tensile strength, shear resistance, chemical and/or molecular descriptor properties that comprise bio-active/bioavailability properties, molecular structure, phytonutrient properties, sensorial properties that comprise taste, smell, color, texture, mouth feel, and nutritional information that comprises macronutrient/micronutrient properties.
